(19) United States
(12) Patent Application Publication
(10) Pub. No.: US 2015/0160385 A1
(43) Pub. Date: Jun. 11, 2015

(54) BIRD ANTI-COLLISION WINDOW FILM

(71) Applicant: Artscape Inc., Portland, OR (US)

(72) Inventor: Thomas HICKS, Portland, OR (US)

(73) Assignee: Artscape Inc., Portland, OR (US)

(21) Appl. No.: 14/623,830

(22) Filed: Feb. 17, 2015

Related U.S. Application Data
(63) Continuation-in-part of application No. 11/833,942, filed on Aug. 3, 2007, now abandoned.
Application No. 11/833,942 is a division of application No. 10/846,807, filed on May 13, 2004, now abandoned.

(51) Int. Cl. G02B 5/20; G02B 5/22

(52) U.S. Cl. CPC G02B 5/208; G02B 5/223

(57) ABSTRACT

A bird anti-collision film prevents birds from flying into windows by disrupting visible habitat reflections that might appear on the outside of the windows. Instead of simply blocking or absorbing light, the anti-collision film actively refracts and scatters light generating an active light disturbance. The refracted light includes an ultraviolet light range visible by many birds. A textured surface and an optical brightener increase the intensity of the refracted light disturbance. The anti-collision film increases active light disturbance intensity when attached to the inside of a window providing the unique advantages of easy inside window installation and insulation from external weather conditions.

This application is a continuation in part of U.S. patent application Ser. No. 11/833,942, filed Aug. 3, 2007, entitled TEXTURED WINDOW FILM, which is a divisional of U.S. patent application Ser. No. 10/846,807, filed May 13, 2004, entitled TEXTURED WINDOW FILM, which are all herein incorporated by reference in their entirety.

This application incorporates by reference in its entirety U.S. Pat. No. 7,468,203, filed May 13, 2004, entitled TEXTURED WINDOW FILM.

### TECHNICAL FIELD

This invention relates generally to bird anti-collision window films.

### BACKGROUND OF THE INVENTION

Buildings are using larger windows. For example, the outside walls of many high rise buildings are made up almost entirely of windows. May single family homes, as well has high rise condominiums, have large widows or sliding glass doors that take up most of the surrounding wall space. Birds may collide into these large windows. For example, the windows may reflect light from surrounding outside habitat. The birds are fooled by the reflections and fly into the windows causing injury and/or death. The number of birds that collide into windows has reached epidemic levels with bird mortality rates in the United States caused by window collisions reported at around 1,200,000,000 per year.

To avoid bird collisions, decals are placed on the outside of the windows to disrupt the reflected images. However, these decals have limited success preventing bird collisions. Chances of even moderate success require attaching a large numbers of the decals to the outside of the window.

Many windows have restricted outside access, do not open, or are located high above the ground. Applying decals on the outside of these windows is difficult, expensive, and/or dangerous. Large numbers of decals placed on the outside of windows also reduce overall building aesthetics and have reduced operating life from exposure to outside weather conditions.

### BRIEF DESCRIPTION OF THE DRAWINGS

FIG. 1 is a perspective view of a bird anti-collision window film.

FIG. 2 is side sectional view of the bird anti-collision window film.

FIG. 3A is a front view of a line pattern used in the bird anti-collision window film.

FIG. 3B is another sectional view of the bird anti-collision window film.

FIG. 4 is a front view of another line pattern used in the bird anti-collision window film.

FIG. 5 is a graph showing UV light intensity created by the bird anti-collision window film.

FIGS. 6, 7, and 8 show screen printing stages used for creating the bird anti-collision window film.

FIGS. 9 and 10 show screen printing stages used for a colored bird anti-collision window film.

### DESCRIPTION OF THE PREFERRED EMBODIMENTS

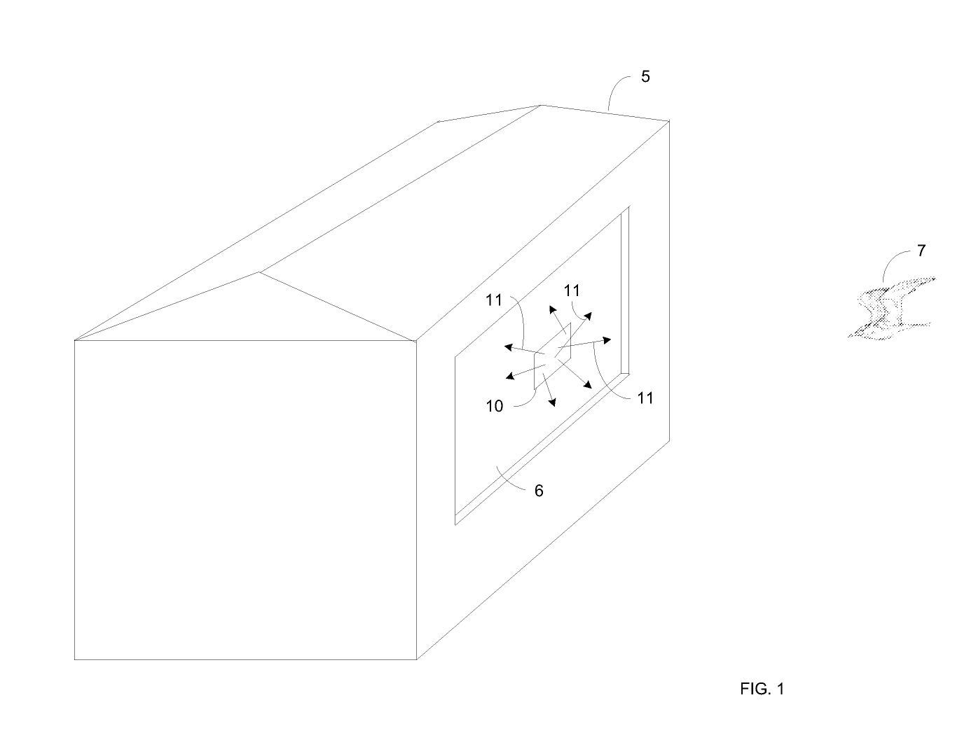

FIG. 1 shows a bird anti-collision film 10 attached to the inside of a window 6 installed in a building 5. This is just one example and window 6 may comprise a sliding glass door or any other transparent material located in any home, building, or other any other structure. Window 6 may reflect images of habitat that exist outside of building 5. For example, the light reflected by window 6 may appear as part of landscape, trees, mountains, etc. A bird 7 flying in the direction of building 5 may mistake the reflection as part of the outside habitat and unintentionally fly into window 6.

Anti-collision film 10 reflects and refracts light coming from outside of building 5 back out through window 6 as disrupted light 11. It is believed that disrupted light 11 not only disrupts visible light reflections by window 6 but also radiates back out through window 6 with an increased intensity or glow. Instead of simply blocking or absorbing light, anti-collision film 10 actively refracts and scatters light generating active light disturbance 11. Disrupted light 11 includes ultraviolet (UV) light visible by many birds. The refracted UV light 11 provides additional visual warnings that help bird 7 avoid running into window 6.

Attaching anti-collision film 10 to the inside of window 6 provides the unique advantages of increased disrupted light intensity, UV light refraction, easy application, and insulation from external weather conditions. The increased intensity of refracted light 11 means a smaller amount of anti-collision film 10 is needed compared to conventional window decals. The reduced amount and/or size of anti-collision film 10 may improve aesthetics on the inside and outside of building 5.

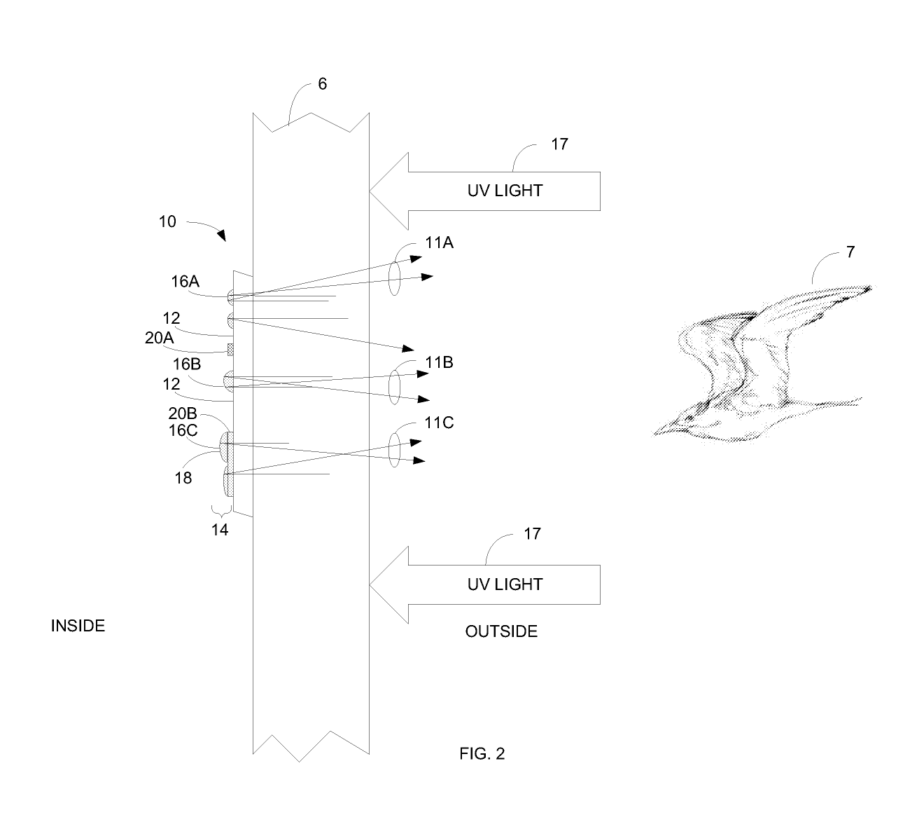

FIG. 2 shows bird anti-collision film 10 in more detail. Film 10 includes a first relatively flat base layer 12 and a second textured layer 14 that in one example comprises different patterns of bumps or other protuberances 16. In one example, base layer 12 may comprise a polymeric film and textured layer 14 may comprise a layer of resin applied over polymeric film 12. In another example, base layer 12 may comprise a layer of resin applied over a polymeric film and textured layer 14 may comprise a second layer of resin applied over resin layer 12. These are just examples and film 10 may include additional combinations of resin and polymeric films.

Light 17 comes from outside of a building and passes through window 6 and base layer 12. Textured layer 14 reflects and refracts incoming light 17, including UV light, back out of window 6 as disrupted light 11. Disrupted light 11 exits window 6 at different angles and increased intensities causing what is believed to be a radiating or glowing effect at least within the UV light range. The radiating UV and other frequencies within light 11 substantially disrupt visible light reflections of window 6 and are believed to be highly noticeable by many types of birds 7.

An optical brightener 18 may be mixed into the resin of textured layer 14 to increase the intensity of light 11. One example optical brightener 18 is the Uvitex OB NSICH221 manufactured by Nazdar Ink Technologies, 8501 Hedge Lane Terrace, Shawnee, Kans. 66227.

To further disrupt window reflections, bumps 16 in textured layer 14 are formed into different shapes and/or patterns. Similar to the lens in a lighthouse, bumps 16 may operate like a lens magnifying refracted light 17. Magnification by bumps 16 further contribute to the intensity of refracted light 11 and the amount of visual warning provided to bird 7.

Bumps 16A, 16B, and 16C may form separate line patterns on base layer 12. The line patterns may form separate rows, columns, circles, squares, or any other shape. The line patterns formed by bumps 16A, 16B, and 16C are spaced apart by substantially flat surfaces of layer 12. The spaced apart line patterns may create separate discontinuous light groups 11A, 11B, and 11C that further disrupt any images normally reflected by window 6.

Different ink layers 20A and 20B may be printed onto base layer 12 and/or textured layer 14 to further disrupt visual reflections from window 6. For example, ink layer 20A is printed onto a portion of base layer 12 with no textured layer 14 and ink layer 20B is printed onto another portion of base layer 12 underneath textured layer 14. In another example, ink layers 20 may be printed over both textured layer 14 and base layer 12. In other examples, ink may be mixed into the resin of base layer 12 and/or textured layer 14. Ink layers 20 may form any combination of colors and/or patterns and may create additional discontinuities in reflected and refracted light 11.

In one example, UV absorbing inhibitors are mixed into or printed onto base layer 12 or ink layers 20. The combination of optical brighteners 18 in textured layer 14 and UV inhibitors in base layer 12 and/or link layers 20 further add to the visual discontinuities in refracted light 11.

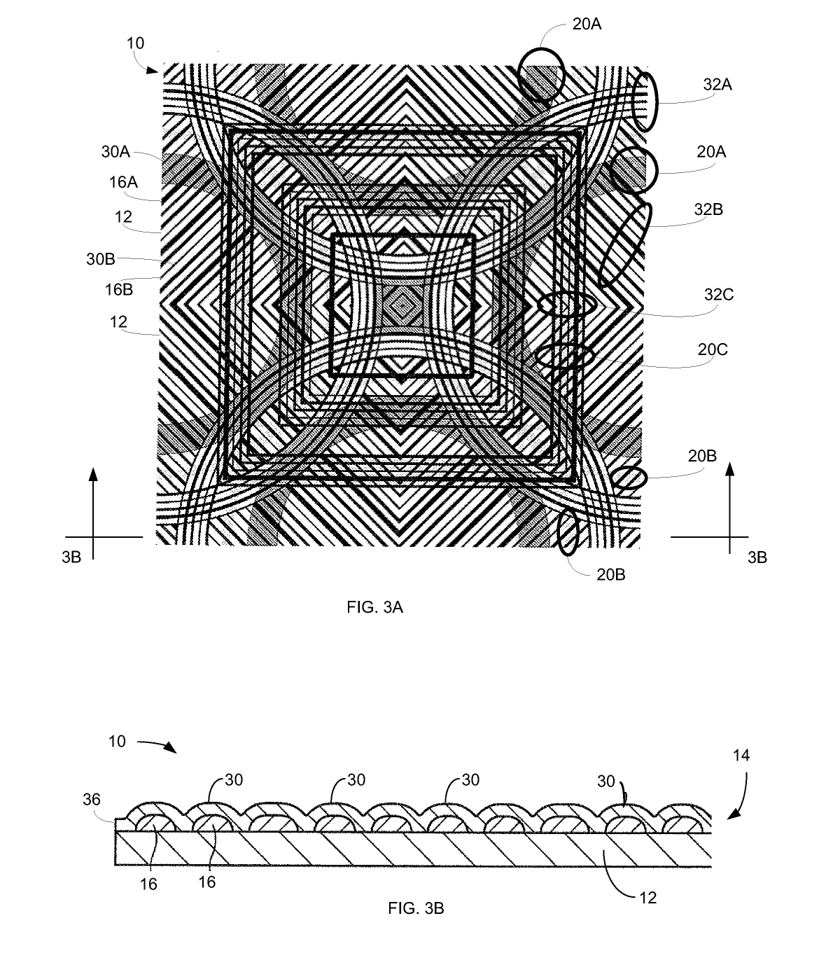

FIG. 3A shows one example of textured lines 30 formed in bird anti-collision film 10. White spaces in FIG. 3 represent a top surface of base layer 12 and black lines 30 represent lines of bumps 16 formed in textured layer 14 on top of base layer 12.

Lines 30 on layer 12 are formed into different widths, shapes, and patterns. For example, a series of bumps 16A may form a relatively wide first line 30A on base layer 12 and a second series of bumps 16B may form a relatively narrow line 30B on base layer 12. In one example, some of lines 30 form semi-circular patterns 32A of varying radiuses and orientations. Other lines 30 form square patterns 32B of varying sizes. Other lines 30 may form square patterns 32C of varying line widths and sizes oriented 90 degrees from square patterns 32B. These of course are just examples of any combination of raised textured line patterns that may be formed on base layer 12.

Different ink layers 20 are printed with different patterns on base layer 12. For example, a first blue ink layer 20A is printed in semi-circular patterns in different orientations on layer 12. A second yellow ink layer 20B is printed in semi-circular patterns in different orientations on layer 12. Another yellow ink layer 20C is printed in a square pattern underneath textured square pattern 32C. These of course are also just examples of any combination of ink layers 20 and colors that can be printed in any combination of patterns on base layer 12 and/or textured layer 14.

Textured spaced apart lines 30 increase discontinuities between radiating and non-radiating sections of light refracted by film 10. As mentioned above, the white areas in FIG. 3 representing base layer 12 may include a UV absorbing material and the black lines 30 representing textured layer 14 may include a UV optical brightener. In another example, some of ink layers 20 may include a UV absorbing material. The UV absorbsion in base layer 12 and/or ink layer 20 in combination with the optical brightening in textured layer 14 may further increase optical discontinuities in the light refracted and reflected by film 10.

Ink layers 20 may be printed on any combination of layers 12 and 14. For example, a first ink layer 20 may be printed on base layer 12, a second link layer 20 may be printed over both textured layer 14 and base layer 12, and a third color may be added as a pigment to base layer 12 or textured layer 14.

FIG. 3B shows a cross-section of bird anti-collision film 10. Resin bumps 16 in textured layer 14 are formed over polymeric film base layer 12. Resin 16 is deposited on top of polymeric film 12 forming lines 30. A second resin clear coat layer 36 of substantially uniform thickness may be deposited over and in-between bumps 16.

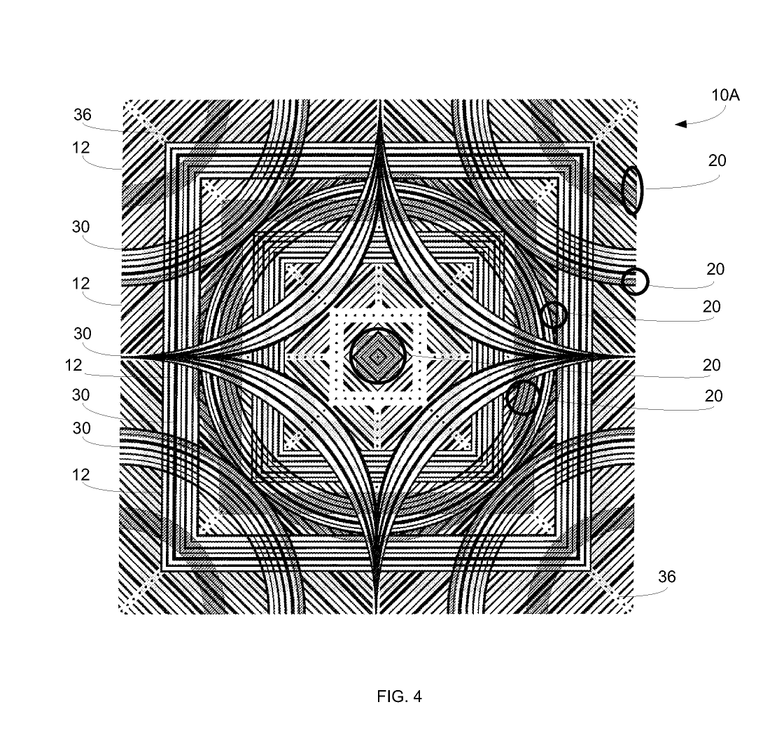

FIG. 4 shows another bird anti-collision film 10A that uses different line patterns. Lines 30 and dots 36 are again formed in textured layer 14 on top of a polymeric film base layer 12 similar to film 10 in FIGS. 3A and 3B. Ink layers 20 may include other combinations of colors and/or patterns.

The different three-dimensional shapes formed by textured lines 30 are believed to create a lens like effect that magnify the reflected and refracted light radiated back out of a window in more noticeable directions. The different reflective properties of the UV reflective additive (optical brightener) in textured layer 14 may create additional visual disruptions further reducing bird collisions.

Ink layers 20 may use a dichroic pigment to create prismatic disruptions. For example, one of ink layers 20 may appear as a rose color when viewing film 10 from a first angle outside of a window and the same ink layer 20 may appear as a more cayenne color when viewing anti-collision film 10 from a different angle outside of the window.

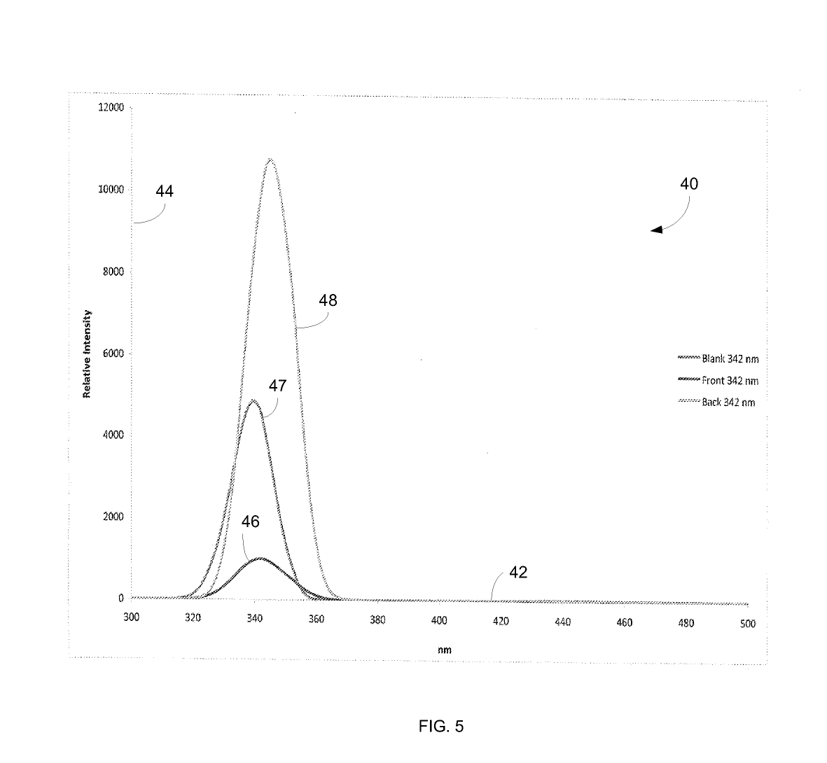

FIG. 5 shows some reflection characteristics of bird anti-collision film 10. Humans typically have visual light ranges between 390 nanometers (nm) and 700 nm. Many birds and insects typically have visual light ranges between 320 nm and 700 nm that include a portion of the UV light range between 10 nm and 400 nm.

A graph 40 shows relative reflection intensity for a portion of the ultraviolate (UV) light range between 320 nanometers (nm) and 370 nm. Axis 42 in graph 40 represents light wavelengths and axis 44 represents a relative intensity or reflectivity for UV light applied to the outside of window 6 in FIGS. 1 and 2. Values on axis 44 may correspond to percentages of the UV light reflected and/or refracted back outside of window 6.

Curve 46 represents the intensity of light reflected back by window 6 with no anti-collision film 10. Curve 47 represents the intensity of UV light reflected back when anti-collision film 10 is applied to the outside surface of window 6 and curve 48 represents the intensity of UV light reflected back when by anti-collision film 10 is applied to the inside surface of window 6 as shown in FIGS. 1 and 2.

As shown by curve 48, anti-collision film 10 has the unique characteristic of creating the most UV reflected and refracted light intensity when attached to the inside surface of window 6. The substantially larger relative light intensity represented by curve 48 shows that the light reflected and refracted by anti-collision film 10 may substantially interrupt typical light reflections by window 6 as represented by curve 46. In other words, anti-collision film 10 effectively “lights up” a section of window 6 with disturbed reflected and refracted UV light visible to birds.

### Multi-Layer Screen Process

One example uses a multi-layer screen printing process commonly known as screen printing for creating bird anti-collision window film 10. While a screen printing process is described below, it should be understood that any other screen or non-screen process can be used that produce a textured surface on a window film.

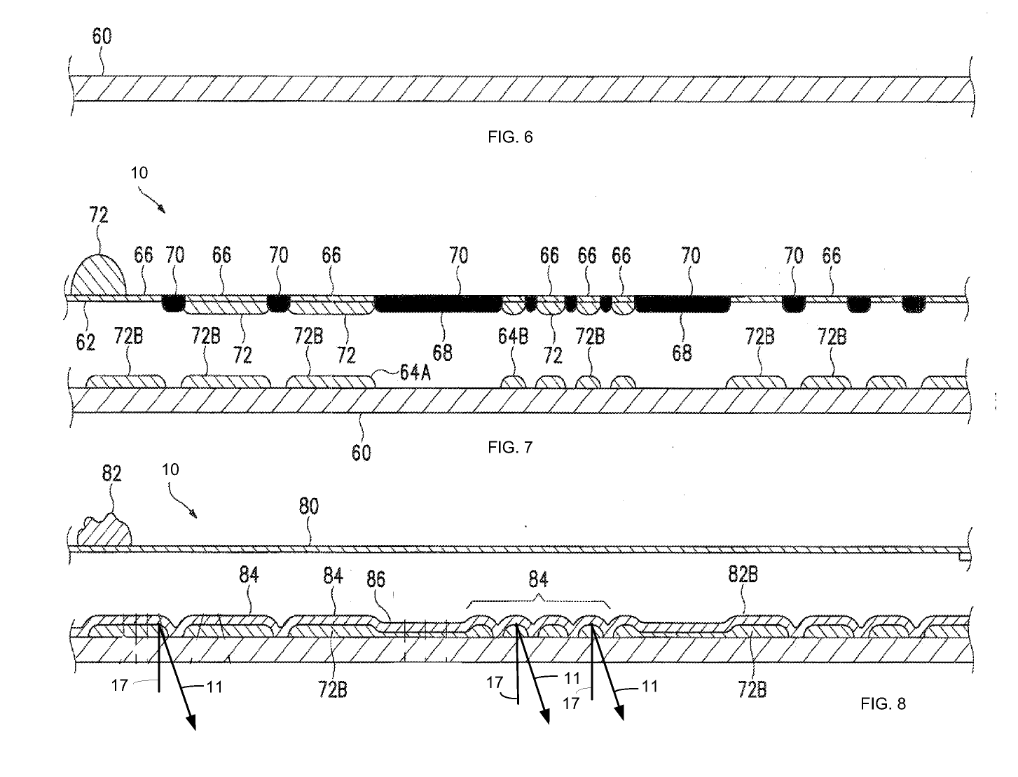

FIG. 6 shows a polymeric film 60 used as a substrate for the screen printing process. In one example, polymeric film comprises non-textured base layer 12 described above and can be any type of translucent, transparent, or clear material that can be attached to a window. In one example, polymeric film 60 is a polyvinyl material that attaches to a window using cohesion and atmospheric pressure. Polymeric film 60 can be any thickness but in one example is anywhere between 0.5 thousands of an inch (mils) and 10 mils In embodiment, polymeric film 60 is a transparent and in other embodiments film 60 may be colored or have varying degrees of opaqueness as described above.

FIG. 7 shows a first stage of the screen printing process. A screen 62 is used to print a first resin layer 72B on top of polymeric film 60. A pattern is formed in areas 66 in one example using a photosensitive emulsion 68 that is applied as either a liquid coating or in sheet form. A pattern is applied over emulsion 68 and emulsion 68 is then exposed to light. For example, one of the patterns shown in FIGS. 3A or 4 may be applied over emulsion 68. The areas in emulsion 68 that were covered by the pattern remain soft and are washed out forming open areas 66. Areas 70 not covered by the pattern remain blocked off with emulsion 68.

In a next process, screen 62 is located over polymeric film 60 and a resin material 72 is spread over screen 62. Using a squeegee, resin 72 is spread through unblocked areas 66 in screen 62 and onto the top surface of polymeric film 60 forming resin layer 72B. Resin layer 72B forms textured layer 14 and associated bumps 16 and lines 30 as described above. In one example, resin material 72 may include optical brighteners 18 described above in FIG. 2. In other examples resin material 72 is clear or includes other degrees of opaqueness or color.

The size and shape of individual areas 66 can be relatively consistent or can vary in shape, size or spacing as shown above in FIGS. 3 and 4. If areas 66 have different shapes, then the corresponding bumps 64A and 64B and associated lines 30 formed in resin layer 72B will also have different shapes and sizes. It should be noted that the variable size and shape of the bumps 64A and 64B formed in resin layer 72B help promote the random or semi-random refraction of light as shown above.

In one embodiment, screen 62 has a thread count in the range of between 65-420 threads per inch and the thickness of the photosensitive emulsion 68 used to coat screen 62 is anywhere between 1 mil-100 mils. But in the example in FIG. 7, screen 62 is coated with emulsion 68 to a depth of about 6.0-8.5 mils The range of 6.0-8.5 mils of emulsion 68 produces a thickness for resin layer 72B of around 1.0-5.5 mils.

In one example, resin 72 uses acrylated oligomers by weight in a range of about 20-55%, N-Vinyl-2 Pyrrolidone by weight of about 12-25%, and acrylated monomers by weight of about 8-20%. Resin 72 may contain similar elastic and pliability characteristic as polymeric film 60. This increases the ease in which film 10 can be applied to a window while also increasing durability. Of course this is only one example and other types of resin materials can also be used. The specific dimensions and materials used can be changed to created different lighting and application characteristics.

As mentioned above, textured layer 72B may include an optical brightener. Textured layer 72B with the optical brighteners reflects, refracts and/or bends incoming light 17 so the increased intensity reflected and refracted outgoing light 11 distorts reflected images.

FIG. 8 shows a second screening process applied to anti-collision film 10. A second screen 80, similar to screen 62 in FIG. 7, is used except screen 80 does not have a pattern formed from emulsion. In one example, screen 80 comprises a uniform mesh of between about 110-420 threads per inch and is large enough to cover the entire resin layer 72B. A second resin, clear varnish or clear coat 82 is spread over screen 80 applying a second substantially even resin layer 82B over first resin layer 72B.

Second resin layer 82B in one embodiment may be less viscous than the first resin layer 72B and may comprise a mixture of TRPGDA by weight in a range of about 20-25%, epoxy acrylate by weight in a range of about 50-56%, HDOCA by weight in a range of about 18-22%, and photoinitiators by weight in a range of about 3-5%. Of course other materials can also be used to form the second resin layer 82B. In one example, resin layer 82B also may include a UV inhibitor.

### Color

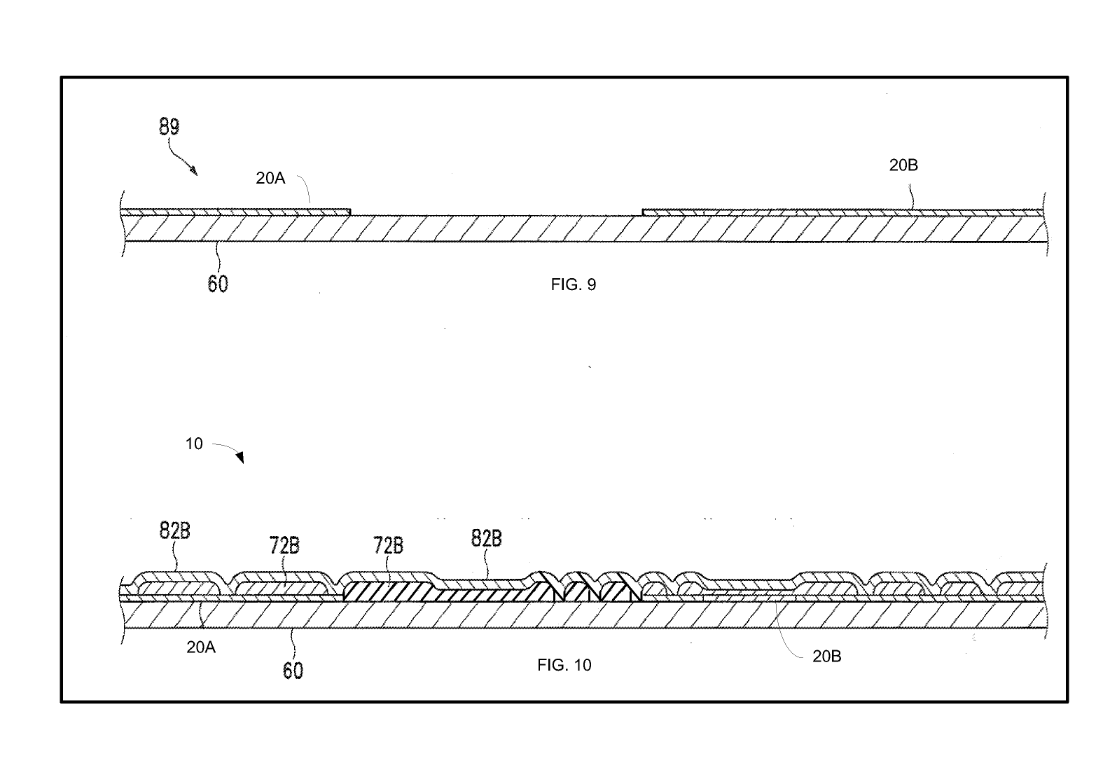

FIG. 9 shows one example where ink layers 20A and 20B are applied to a top surface of polymeric film 60. One example uses an offset lithography process to form ink layers 20. However, any other process can also be used to apply ink layers 20 on the polymeric film 60, such as by using an ink jet printing process or a screen printing process similar to that used for applying the resin layers.

In one example, ink used to form ink layer 20 is made of an elastic material that has similar elastic characteristics as the polymeric layer 60 and the resin layers 72B and 82B. The elastic characteristics of ink layers 20 make it more resistant to cracking. Ink layers 20 are optional and other embodiments of the textured window film, such as the textured window film 10 described above in FIGS. 6-8, may not use ink layer 90.

One example of an ink material as described above includes 10-30% by weight Triacrylate Monomer; 10-30% by weight Acrylate Oligomer; 1-5% by weight Hydroxycyclohccyl, 1-,Phenyl Kclone; 1-5% by weight 1-Propanone, 2-methyl-1[4-(methylthio) phenyl]-2-(4-morpholinyl)-; 1-5% by weight Photoinitiator; and 1-5% by weight Pentacrythritol Tetraacrylate made by INX International Ink Co., 651 Bonnie Lane, Elk Grove Village, Ill. 60007.

Another ink material uses Monomeric Multifunctional Acrylates; Multi-Functional Acrylate Ester; Benzophenone; Acrylate Ester of Bisphenol-A-Epoxy; Multifunctional Acrylate; Isopropyl Alcohol; Inorganic filler; and Ketone type photo-initiator. Of course are just examples and other types of ink materials could also be used.

FIG. 10 shows resin layers 72B and 82B applied on top of ink layers 20A and 20B. Resin layers 72B and 82B are applied in the same manner described above in FIGS. 6-8. In one example ink layers 20A and 20B may have different colors and shapes and may use different dichroic pigments and/or UV inhibitors. In another example, polymeric layer 60, resin layer 72B, and/or resin layer 82B also may include UV absorbing inhibitors.

The processes described above are only examples of a combination of textures that are created on the polymeric film. It should also be understood that limitless combinations of screens, emulsion and resin materials can be used to create different textured surfaces. For example, the different patterns on the screen meshes, the thread counts (mesh count) on the screen meshes and the thickness of the emulsions and resins applied to the screens can all be varied to create different textured line patterns with different thicknesses and shapes.

A screen with a lower thread count per inch produces a coarser mesh that allows more of the resin to pass through onto the polymeric substrate. This can produce different shapes and heights of the bumps and line patterns on the textured surface. These different bump and line heights in combination with the textured surface pattern and any ink pattern applied during the process can create a limitless combination of reflection and refraction characteristics.

### Installation

Another advantage of the process described above is the ease that the anti-collision film 10 can be applied to and removed from a window. For example, the smooth/flat contact of polymeric film 60 allows the anti-collision film 10 to be applied without the use of adhesive materials. Anti-collision film 10 is held to the window surface by cohesion and atmospheric pressure. While this is one embodiment, other embodiments of anti-collision film 10 can apply an adhesive material to the window contact surface.

In one embodiment, a paper or polyester liner (not shown) is applied to the smooth side of polymeric film 60 so that it can be rolled and packaged for commercial sale. The paper liner is held to the polymeric film by the same cohesion and atmospheric pressure that is used to hold anti-collision film 10 to a window.

The liner used with anti-collision film 10 is easier to remove from the back of the polymeric film than the liners used with other window films. Other window films include a backing that has to be removed from the film using water, razor blades, tape, or some other prepatory procedures. To install film 10, the paper is simply pealed off the flat surface of polymeric film 60 and the film pressed against a wet or dry glass surface. No additional surface preparation is generally required however in one embodiment soapy water is applied to the film surface or to the window during application to reduce air bubbles. Anti-collision film 10 can be easily cut using scissors or a knife to create any desired shape.

Anti-collision film 10 in one embodiment is thicker than conventional widow films. This makes film 10 more resilient to bending and creasing and in general makes the material easier to work with. The polymeric substrate and resin layers in combination with any applied ink also have a flexible and stretchable characteristic that further prevent film 10 from cracking and otherwise being damaged during application or removal from a window. The materials described above for forming anti-collision film 10 also do not require any special cleaning process. Thus, conventional window cleaners can be used.

Having described and illustrated the principles of the invention in a preferred embodiment thereof, it should be apparent that the invention may be modified in arrangement and detail without departing from such principles. We claim all modifications and variation coming within the spirit and scope of the following claims.

1. An anti-collision film, comprising:
a polymeric film having a first side configured to attach to a window;
a textured layer covering some areas of a second side of the polymeric film while leaving other areas of the second side of the polymeric film uncovered; and
an optical brightener mixed into the textured layer configured to increase an intensity of ultraviolet (UV) light reflected and refracted by the anti-collision film back out through the first side of the polymeric film.

2. The anti-collision window film of claim 1, wherein the polymeric film includes a UV absorbsion material.

3. The anti-collision window film of claim 1, including an ink layer applied over the polymeric film and/or the textured layer.

4. The anti-collision window film of claim 3, wherein the ink layer includes a dichroic pigment.

5. The anti-collision window film of claim 3, wherein the ink layer includes a UV inhibitor.

6. The anti-collision window film of claim 1, wherein the textured layer forms spaced apart textured line patterns on the polymeric film.

7. The anti-collision window film of claim 6, wherein the line patterns include square line patterns of varying sizes and varying orientations.

8. The anti-collision window film of claim 7, including an ink layer with a square shape located underneath a set of the square line patterns.

9. The anti-collision window film of claim 6, wherein the line patterns include semi-circular line patterns of varying diameters and varying orientations.

10. The anti-collision window film of claim 9, including an ink layer with a semi-circular shape located underneath a set of the semi-circular line patterns.

11. The anti-collision window film of claim 1, including a substantially uniform second layer extending over the first textured layer and over the uncovered areas of the polymeric film.
